(19) United States
(12) Patent Application Publication
(10) Pub. No.: US 2007/0027258 A1
(43) Pub. Date: Feb. 1, 2007

(54) Thermoplastic resin composition

(75) Inventors: Taizo Aoyama, Takasago-shi (JP); Masanobu Urakami, Nishinomiya-shi (JP)

Correspondence Address: HOGAN & HARTSON L.L.P., 1999 AVENUE OF THE STARS, SUITE 1400, LOS ANGELES, CA, 90067, US

(73) Assignee: KANEKA CORPORATION

(21) Appl. No.: 11/479,985

(22) Filed: Jun. 29, 2006

Related U.S. Application Data
(60) Provisional application No. 60/697,035, filed on Jul. 6, 2005.

(51) Int. Cl. C08L 53/00

(52) U.S. Cl. 525/92 C

(57) ABSTRACT

The present invention has its object to provide a thermoplastic resin composition which comprises an isobutylene-based block copolymer and a thermoplastic polyurethane resin, and low in hardness and excellent in oil resistance, transparency, thermal stability, mechanical strength and the like. The present invention provides a thermoplastic resin composition which comprises 30 to 95 parts by weight of (a) an isobutylene-based block copolymer constituted of a polymer block the main constituent of which is isobutylene and a polymer block derived from a monomer composition the main constituent of which is not isobutylene and 70 to 5 parts of a thermoplastic polyurethane resin.

### TECHNICAL FIELD

The present invention relates to a thermoplastic resin composition comprising a specific isobutylene-based block copolymer and a thermoplastic polyurethane resin. The thermoplastic resin composition of the invention is applicable in such fields of industry as food, daily goods, toy/sporting goods, stationery, auto interior and exterior, civil engineering/building, household electric appliance, clothing/footwear, medical, hygienic, packaging/transportation and electric wire industries in view of the low hardness, good oil resistance, transparency, good thermal stability and excellent mechanical strength which can be provided by the composition. In particular, it is suited for use in the field of daily goods where oil resistance and low hardness are required.

### BACKGROUND ART

In recent years, thermoplastic elastomers which are rubber-like flexible materials but do not require any vulcanization step but can be molded and processed in the same manner as thermoplastic resins have attracted attention. Various polymers based on polyolefins, polyurethanes, polyesters, polystyrenes and the like have so far been developed as such thermoplastic elastomers and are on the market.

Among these thermoplastic elastomers, polystyrene-based thermoplastic elastomers (Japanese Kokai Publication Hei-11-293083) are in wide use from the processability and cost viewpoint. However, none of them can satisfy all the following requirements: low hardness, oil resistance, transparency, thermal stability and the like.

### SUMMARY OF THE INVENTION

It is an object of the present invention to provide a thermoplastic resin composition excellent in lower hardness, oil resistance, transparency and thermal stability.

The present inventors made intensive investigations to accomplish the above object and, as a result found that a thermoplastic resin composition comprising a specific isobutylene-based block copolymer and a thermoplastic polyurethane resin can solve the problems mentioned above. This finding has now led to completion of the present invention.

Thus, the present invention relates to

a thermoplastic resin composition

which comprises 30 to 95 parts by weight of (a) an isobutylene-based block copolymer constituted of a polymer block the main constituent of which is isobutylene and a polymer block derived from a monomer composition the main constituent of which is not isobutylene and 70 to 5 parts of a thermoplastic polyurethane resin.

In a preferred embodiment, the invention relates to

a thermoplastic resin composition

wherein, in the isobutylene-based block copolymer (a), the monomer composition the main constituent of which is not isobutylene is a monomer composition the main constituent of which is an aromatic vinyl monomer.

In a preferred embodiment, the invention relates to

the above-mentioned thermoplastic resin composition

wherein the aromatic vinyl monomer comprises at least one species selected from the group consisting of styrene, p-methylstyrene, α-methylstyrene and indene.

In a preferred embodiment, the invention relates to

a thermoplastic resin composition

wherein the isobutylene-based block copolymer (a) comprises at least one species selected from the group consisting of triblock copolymers composed of a polymer block the main constituent of which is an aromatic vinyl monomer, a polymer block the main constituent of which is isobutylene and a polymer block the main constituent of which is an aromatic vinyl monomer, diblock copolymers composed of a polymer block the main constituent of which is an aromatic vinyl monomer and a polymer block the main constituent of which is isobutylene, and star block copolymers comprising at least three arms each composed of a polymer block the main constituent of which is an aromatic vinyl monomer and a polymer block the main constituent of which is isobutylene.

### DETAILED DESCRIPTION OF THE INVENTION

The isobutylene-based block copolymer (a) to be used in the practice of the invention is not particularly restricted but may be any one comprising a polymer block the main constituent of which is isobutylene and a polymer block the main constituent of which is not isobutylene. Thus, for example, it can be selected from among block copolymers, diblock copolymers, triblock copolymers and multiblock copolymers each having a linear, branched or star structure, and the like. Preferred as the block copolymer from the physical property balance and softening agent absorbing capacity viewpoint are, for example, triblock copolymers composed of a polymer block derived from a monomer composition the main constituent of which is not isobutylene, a polymer block the main constituent of which is isobutylene and a polymer block derived from a monomer composition the main constituent of which is not isobutylene, diblock copolymers composed of a polymer block derived from a monomer composition the main constituent of which is not isobutylene and a polymer block the main constituent of which is isobutylene, and star block copolymers comprising at least three arms each composed of a polymer block derived from a monomer composition the main constituent of which is not isobutylene and a polymer block the main constituent of which is isobutylene. These may be used singly or two or more of them may be used in combination so that the desired physical properties and moldability/processability may be obtained.

The monomer composition the main constituent of which is not isobutylene, as so referred to herein, is a monomer composition in which the content of isobutylene is not higher than 30% by weight. The content of isobutylene in the monomer composition the main constituent of which is not isobutylene is preferably not higher than 10% by weight, more preferably not higher than 3% by weight.

The monomer other than isobutylene in the monomer composition the main constituent of which is not isobutylene, as so referred to herein, is not particularly restricted but may comprise any cationically polymerizable monomer or monomers. As examples, there may be mentioned aliphatic olefins, aromatic vinyl compounds, dienes, vinyl ethers, silanes, vinylcarbazole, β-pinene and acenaphthylene. These are used singly or two or more of them are used in combination.

As the aliphatic olefins, there may be mentioned ethylene, propylene, 1-butene, 2-methyl-1-butene, 3-methyl-1-butene, pentene, hexene, cyclohexene, 4-methyl-1-pentene, vinylcyclohexane, octene, norbornene and the like.

As the aromatic vinyl monomers, there may be mentioned styrene, o-, m- or p-methylstyrene, α-methylstyrene, β-methylstyrene, 2,6-dimethylstyrene, 2,4-dimethylstyrene, α-methyl-o-methylstyrene, α-methyl-m-methylstyrene, α-methyl-p-methylstyrene, β-methyl-o-methylstyrene, β-methyl-m-methylstyrene, β-methyl-p-methylstyrene, 2,4,6-trimethylstyrene, α-methyl-2,6-dimethylstyrene, α-methyl-2,4-dimethylstyrene, β-methyl-2,6-dimethylstyrene, β-methyl-2,4-dimethylstyrene, o-, m- or p-chlorostyrene, 2,6-dichlorostyrene, 2,4-dichlorostyrene, α-chloro-o-chlorostyrene, α-chloro-m-chlorostyrene, α-chloro-p-chlorostyrene, β-chloro-o-chlorostyrene, β-chloro-m-chlorostyrene, β-chloro-p-chlorostyrene, 2,4,6-trichlorostyrene, α-chloro-2,6-dichlorostyrene, α-chloro-2,4-dichlorostyrene, β-chloro-2,6-dichlorostyrene, β-chloro-2,4-dichlorostyrene, o-, m- or p-tert-butylstyrene, o-, m- or p-methoxystyrene, o-, m- or p-chloromethylstyrene, o-, m- or p-bromostyrene, silyl group-substituted styrene derivatives, indene, vinylnaphthalene and the like.

As the diene monomers, there may be mentioned butadiene, isoprene, hexadiene, cyclopentadiene, cyclohexadiene, dicyclopentadiene, divinylbenzene, ethylidenenorbornene and the like.

As the vinyl ether monomers, there maybe mentioned methyl vinyl ether, ethyl vinyl ether, (n-, iso)propyl vinyl ether, (n-, sec-, tert-, iso) butyl vinyl ether, methyl propenyl ether, ethyl propenyl ether and the like.

As the silane compounds, there may be mentioned vinyltrichlorosilane, vinylmethyldichlorosilane, vinyldimethylchlorosilane, vinyldimethylmethoxysilane, vinyltrimethylsilane, divinyldichlorosilane, divinyldimethoxysilane, divinyldimethylsilane, 1,3-divinyl-1,1,3,3-tetramethyldisiloxane, trivinylmethylsilane, γ-methacryloyloxypropyltrimethoxysilane, γ-methacryloyloxypropylmethyldimethoxysilane and the like.

From the physical properties and polymerization behavior characteristics viewpoint, the monomer composition the main constituent of which is not isobutylene, which is to be used in the practice of the invention, is preferably a monomer composition the main constituent of which is an aromatic vinyl monomer. The aromatic vinyl monomer-based composition herein indicates a monomer composition having an aromatic vinyl monomer content of not lower than 60% by weight, preferably not lowerthan 80% byweight. Preferablyusedasthe aromaticvinyl monomer is at least one monomer selected from the group consisting of styrene, α-methylstyrene, p-methylstyrene and indene. From the cost viewpoint, the use of styrene, α-methylstyrene or a mixture of these is particularly preferred.

In the practice of the invention, the monomer composition the main constituent of which is isobutylene may contain or be free of a monomer other than isobutylene and generally is a monomer composition having an isobutylene content of not lower than 60% by weight, preferably not lower than 80% by weight. The monomer other than isobutylene is not particularly restricted but may be any cationically polymerizable monomer. It includes, for example, those monomers mentioned hereinabove.

The proportion between the polymer block the main constituent of which is isobutylene and the polymer block derived from a monomer composition the main constituent of which is not isobutylene is not particularly restricted. From the physical properties viewpoint, however, the polymer block the main constituent of which is isobutylene preferably amounts to 95 to 40% by weight and the polymer block derived from a monomer composition the main constituent of which is not isobutylene to 5 to 60% by weight. Particularly preferably, the polymer block the main constituent of which is isobutylene amounts to 85 to 50% by weight and the polymer block derived from a monomer composition the main constituent of which is not isobutylene to 15 to 50% by weight.

The number average molecular weight of the isobutylene-based block copolymer is not particularly restricted, either. From the flowability, processability and physical properties viewpoint, for example, it is preferably 30,000 to 500,000, particularly preferably 50,000 to 400,000. When the isobutylene-based block copolymer has a number average molecular weight below the above range, the phenomenon of softening agent bleeding out tends to occur and the mechanical physical properties may be manifested only to an insufficient extent. Conversely, molecular weight levels exceeding the above range are disadvantageous from the flowability and processability viewpoint.

As for the method for producing the isobutylene-based block copolymer, there is no particular restriction. The polymer can be obtained, for example, by polymerizing a monomer composition the main constituent is isobutylene and a monomer composition the main constituent is not isobutylene in the presence of a compound represented by the general formula (1):
(CR¹R²X)nR³ (1)
wherein X is a substituent selected from the group consisting of halogen atoms and alkoxy or acyloxy groups containing 1 to 6 carbon atoms, R¹ and R² may be the same or different and each is a hydrogen atom or a monovalent hydrocarbon group containing 1 to 6 carbon atoms, R³ is a polyvalent aromatic hydrocarbon group or a polyvalent aliphatic hydrocarbon group and n represents a natural number of 1 to 6.

The compound represented by the above general formula (1) serves as an initiator; presumably, it forms a carbocation in the presence of a Lewis acid, for example, and thus provides an initiation site for cationic polymerization. As examples of the compound of general formula (1) tobe used in the practice of the invention, there may be mentioned such compounds as enumerated below.

(1-Chloro-1-methylethyl)benzene [C₆H₅C(CH₃)₂Cl], 1,4-bis(1-chloro-1-methytlethyl)benzene [1,4-Cl(CH₃)₂CC₆H₄C(CH₃)₂Cl], 1,3-bis(1-chloro-1-methylethyl)benzene [1,3-Cl(CH₃)₂CC₆H₄C(CH₃)₂Cl], 1,3,5-tris(1-chloro-1-methylethyl)benzene [1,3,5-(ClC(CH₃)₂)₃C₆H₃], 1,3-bis(1-chloro-1-methylethyl)-5-(tert-butyl)benzene [1,3-(C(CH₃)₂Cl)₂-5-(C(CH₃)₃)C₆H₃].

Particularly preferred among these are bis(1-chloro-1-methylethyl)benzene [C₆H₄(C(CH₃)₂Cl)₂] and tris(1-chloro-1-methylethyl)benzene [(ClC(CH₃)₂)₃C₆H₃]. [Bis(1-chloro-1-methylethyl)benzene is also called bis(α-chloroisopropyl)benzene, bis(2-chloro-2-propyl)benzene or dicumyl chloride, and tris(1-chloro-1-methylethyl)benzene is also called tris(α-chloroisopropyl)benzene, tris(2-chloro-2-propyl)benzene or tricumyl chloride.]

In producing the isobutylene-based block copolymer by polymerization, a Lewis acid catalyst may also be caused to coexist. Such Lewis acid may be any one that can be used in cationic polymerization. Thus, metal halides such as TiCl₄, TiBr₄, BCl₃, BF₃, BF₃·OEt₂, SnCl₄, SbCl₅, SbF₅, WCl₆, TaCl₅, VCl₅, FeCl₃, ZnBr₂, AlCl₃ and AlBr₃; and organometal halides such as Et₂AlCl and EtAlCl₂ can be suitable used. Considering the catalyst capacity and industrial ready availability, TiCl₄, BCl₃ and SnCl₄ are preferred among them. The usage of the Lewis acid is not particularly restricted but may be selected considering the polymerization behavior characteristics and polymerization concentrations of the monomers used, and the like. Generally, the Lewis acid can be used in an amount of 0.1 to 100 mole equivalents, preferably within the range of 1 to 50 mole equivalents, relative to the compound represented by the general formula (1).

In producing the isobutylene-based block copolymer by polymerization, an electron donor component may be caused to coexist where necessary. This electron donor component is considered to be effective in stabilizing the growing carbocation in cationic polymerization and, when an electron donor is added, a polymer controlled in structure and narrow in molecularweight distributionis formed. Theelectron donor component that can be used is not particularly restricted but includes, for example, pyridines, amines, amides, sulfoxides, esters, and metal compounds having one or more metal atom-bound oxygen atoms.

The polymerization for producing the isobutylene-based block copolymer can be carried out in an organic solvent, if necessary. Any organic solvent that will not essentially disturb the cationic polymerization can be used without any particular restriction. Specifically, there maybe mentioned, for example, halogenated hydrocarbons such as methyl chloride, dichloromethane, chloroform, ethyl chloride, dichloroethane, n-propyl chloride, n-butyl chloride and chlorobenzene; benzene and alkylbenzenes such as toluene, xylene, ethylbenzene, propylbenzene and butylbenzene; straight aliphatic hydrocarbons such as ethane, propane, butane, pentane, hexane, heptane, octane, nonane and decane; branched aliphatic hydrocarbons such as 2-methylpropane, 2-methylbutane, 2,3,3-trimethylpentane and 2,2,5-trimethylhexane; alicyclic hydrocarbons such as cyclohexane, methylcyclohexane and ethylcyclohexane; and paraffin oils derived from petroleum fractions by hydrorefining.

These solvents are used singly or in combination of two or more species taking the polymerization behavior characteristics of the monomers used for constituting the block copolymer and the solubility of the polymer to be formed into consideration in a balanced manner.

Considering the viscosity of the polymer solution to be obtained and the ease of heat removal, the usage of the solvent is selected such that the polymer concentration amounts to 1 to 50% by weight, preferably 5 to 35% by weight.

In actually carrying out the polymerization, the respective components are mixed together with cooling, for example at a temperature of not lower than −100° C. but lower than 0° C., and the like. For balancing the energy cost against the stability of polymerization, a temperature range of −30° C. to −80° C. is particularly preferred.

In the practice of the invention, one of various thermoplastic urethane resins, for example of the ester type or ether type, is used as the thermoplastic polyurethane resin (b).

The usage of the (b) component thermoplastic polyurethane resin is such that the proportion of the (a) component isobutylene-basedblock copolymer amounts to 30 to 95% byweight and that of the component (b) to 70 to 5% by weight, preferably such that the proportion of the isobutylene-based block copolymer (a) amounts to 50 to 75% by weight and that of the component (b) to 50 to 25% by weight. When the proportion of (b) is lower than 5% by weight, the thermoplastic resin composition obtained will be low in oil resistance and, when it is higher than 70% by weight, the thermoplastic resin composition obtained will have an increased hardness, hence a reduced feel of flexibility.

If necessary, a polyolefin resin may also be used in the composition of the invention. Usable as the polyolefin resin are one or a combination of two or more of α-olefin homopolymers, random copolymers and block copolymers and mixtures of these, random copolymers, block copolymers and graft copolymers derived from an α-olefin and another unsaturated monomer, and oxidized, halogenated or sulfonated derivatives thereof. More specifically, there maybe mentioned, for example, polyethylene type resins such as polyethylene, ethylene-propylene copolymers, ethylene-propylene-nonconjugated diene copolymers, ethylene-butene copolymers, ethylene-hexene copolymers, ethylene-octene copolymers, ethylene-vinyl acetate copolymers, ethylene-vinyl alcohol copolymers, ethylene-ethyl acrylate copolymers and chlorinated polyethylene, polypropylene type resins such as polypropylene, propylene-ethylene random copolymers, propylene-ethylene block copolymers and chlorinated polypropylene, polybutene, polyisobutylene, polymethylpentene, and cyclic olefin-derived (co)polymers. Among these, polyethylene type resins, polypropylene type resins, or mixtures of these can be preferably used in view of the cost and balanced physical properties of the thermoplastic resin. The level of addition of the polyolefin resin is such that the polyolefin resin amounts to 0 to 100 parts by weight, preferably 0 to 50 parts by weight, more preferably 0 to 30 parts by weight, per 100 parts by weight of the total sum of the isobutylene-based block copolymer (a) and thermoplastic urethane resin (b). Levels exceeding 100 parts by weight increase the hardness and therefore are not preferred.

A softening agent may also be used in the composition of the invention according to need. A material which is liquid or liquid-like at room temperature is generally used, although there is no particular restriction. The softening agent that can be used may be either hydrophilic or hydrophobic. As such softening agent, there may be mentioned mineral oil-based ones, vegetable oil-based ones, and various synthetic softeners for rubbers or resins, and the like. As the mineral oil-based ones, there may be mentioned, for example, process oils of the naphthene or paraffin type, and the like. As the vegetable oil-based ones, there may be mentioned castor oil, cottonseed oil, linseed oil, rapeseed oil, soybean oil, palm oil, coconut oil, peanut oil, Japan wax, pine oil, olive oil, and the like. As the synthetics, there may be mentioned, for example, polybutene and low-molecular-weight polybutadiene. Among these, paraffin-type process oils and polybutene are preferably used in view of the compatibility with the (a) component or the balanced physical properties of the thermoplastic resin composition. It is also possible to use an appropriate combination of two or more of these softening agents so that the desired viscosity and physical properties may be obtained.

The level of addition of the softening agent is 0 to 100 parts by weight, preferably 0 to 50 parts by weight, more preferably 0 to 30 parts by weight, per 100 parts of the total sum of the isobutylene-based block copolymer (a) and thermoplastic urethane resin (b). At levels exceeding 100 parts by weight, the softening agent will unfavorably bleed out.

In the resin composition of the invention, there may further be incorporated a filler for improving the physical properties or from the economical merit viewpoint. As suitable fillers, there may be mentioned, for example, clay, diatomaceous earth, silica, talc, barium sulfate, calcium carbonate, magnesium carbonate, metal oxides, mica, graphite, aluminum hydroxide and other scaly inorganic fillers, various metal powders, wood chips, glass powders, ceramic powders, carbon black, granular or powdery polymers, other granular or powdery solid fillers, and other various natural or artificial short or long fibers. It is also possible to attain reductions in weight by incorporating hollow fillers, for example inorganic hollow fillers such as glass balloons or silica balloons, or organic hollow fillers such as hollow fillers made of a polyvinylidene fluoride or polyvinylidene fluoride copolymer. Furthermore, it is also possible to incorporate any of various blowing agents and/or mechanically incorporate a gas on the occasion of blending so that the weight may be reduced and/or various physical properties such as shock absorbing capacity may be improved.

The level of addition of the filler is 0 to 100 parts by weight, preferably 0 to 50 parts by weight, more preferably 0 to 30 parts by weight, per 100 parts by weight of the total sum of the isobutylene-based block copolymer (a), thermoplastic polyurethane resin (b) and plasticizer. Levels exceeding 100 parts by weight are not preferred since the mechanical strength of the thermoplastic resin composition obtained will then be low and the flexibility will be impaired as well.

Where necessary, an antioxidant and/or ultraviolet absorber may be incorporated in the thermoplastic resin composition of the invention at an addition level of 0.01 to 10 parts by weight, preferably 0.01 to 5 parts by weight, per 100 parts of the thermoplastic resin. Further, there may be added, as other additives, flame retardants, antimicrobial agents, light stabilizers, colorants, flowability-improving agents, lubricants, antiblocking agents, antistatic agents, crosslinking agents, crosslinking aids and the like. These may be used singly or two or more of them may be used in combination. Furthermore, one or more of various thermoplastic resins, thermosetting resins, other thermoplastic elastomers and the like may also be incorporated in the thermoplastic resin composition of the invention at levels at which the performance characteristics of the thermoplastic resin will not be impaired.

The method for producing the thermoplastic resin composition of the invention is not particularly restricted but any of the method known in the art can be applied. For example, the composition can be produced by melting and kneading the respective components mentioned hereinabove, together with an additive component or components as desired, using a heating/kneading apparatus, for example a single-screw extruder, twin-screw extruder, roll, Banbury mixer, Brabender, kneader or high-shear mixer. The order of charging for kneading of the respective components is not particularly restricted but can be determined according to the apparatus used, the workability and/or the physical properties of the thermoplastic resin composition to be obtained.

The thermoplastic resin composition of the invention is applicable in such fields of industry as food, daily goods, toy/sporting goods, stationery, auto interior and exterior, civil engineering/building, household electric appliance, clothing/footwear, medical, hygienic, packaging/transportation and electric wire industries in view of the low hardness, good oil resistance, transparency, good thermal stability and excellent mechanical strength which can be provided by the composition. In particular, it is suited for use in the field of daily goods where oil resistance and low hardness are required.

### BEST MODES FOR CARRYING OUT THE INVENTION

The following examples illustrate the present invention more specifically. These examples are, however, by no means limitative of the scope of the invention, and various appropriate modifications thereof can be made without departing from the spirit of the invention.

In the following examples, the molecular weight of each block copolymer and the physical properties of each thermoplastic resin composition were measured by the methods given below.
(1) Hardness

The hardness was measured in accordance with JIS K 6352. Pressed sheets were used as test specimens.
(2) Oil resistance

The test specimen was immersed in a paraffin oil or IRM #3 oil at room temperature for 72 hours, then taken out of the oil and observed for detecting a change or changes in surface characteristics, if any, and the amount of the oil absorbed was measured.
(3) Mechanical strength and transparency

Each thermoplastic resin composition was compression-molded at 170° C., and JIS #3 dumbbell test specimens were prepared. Breaking strength measurements were carried out at a pulling rate of 500 mm/sec according to JIS K 6251. The transparency of each pressed sheet obtained was judged by visual observation.

Excellent: There is a feel of transparency.

Poor: There is no feel of transparency.
(4) Molecular weight: Waters GPC system (column: Showa Denko K. K.'s Shodex K-804 (polystyrene gel); mobile phase: chloroform). The number average molecular weight was expressed on the polystyrene equivalent basis.
   (Example of Production of an Isobutylene-based Block Copolymer)

A 2-liter reaction vessel equipped with a stirrer was charged with 452 mL of 1-chlorobutane (dried on molecular sieves), 319 mL of hexane (dried on molecular sieves) and 0.55 g of 1,4-bis(1-chloro-1-methylethyl)benzene. The reaction vessel was cooled to −75° C. and then 0.42 g of dimethylacetamide and 182 mL of isobutylene were added. Further, 6.53 mL of titanium tetrachloride was added to initiate the polymerization, and the reaction was continued at −75° C. for 1.5 hours while stirring the solution. Then, 51 g of styrene was added to the reaction mixture, the reaction was further continued for 60 minutes, and the reaction mixture was poured into a large amount of water to thereby terminate the reaction.

The state of separation into an organic layer and an aqueous layer was checked by visual observation. The separability was good and the layers could be easily separated from each other using a separating funnel. The organic layer was washed with two portions of water and, after confirmation of the neutrality of the aqueous layer, poured into a large amount of methanol to cause polymer precipitation. The polymer thus obtained was dried under vacuum at 60° C. for 24 hours to give an isobutylene-based block copolymer (SIBS). The isobutylene-based block copolymer (SIBS) was subjected to GPC analysis. The weight average molecular weight was 72,000 and the styrene content as determined by 1H-NMR was 29% by weight.

A thermoplastic resin composition was prepared using the following materials.
Component (a) block copolymer

Isobutylene-based block copolymer (hereinafter, SIBS for short): The one produced in the production example.

Styrene-ethylene/propylene/styrene block copolymer (hereinafter, SEPS for short): with a number average molecular weight of 72,000 and a styrene content of 29% by weight.
Component (b) thermoplastic polyurethane resin

Thermoplastic polyurethane 1 (hereinafter, TPU-1 for short): ester type, product of DIC Bayer Polymer Ltd. (product name: Pandex T-1375), hardness 75.

Thermoplastic polyurethane 2 (hereinafter, TPU-2 for short): ester type, product of DIC Bayer Polymer Ltd. (product name: Desmopan DP-1060A), hardness 62.

### EXAMPLES 1 TO 5 AND COMPARATIVE EXAMPLES 1 TO 3

The component (a) and component (b) were melt-kneaded in a proportion shown in Table 1 using a mill (Laboplastomill, product of Toyo Seiki Kogyo Co., Ltd.) set at 170° C. Test specimens were prepared by compression molding each thermoplastic resin composition obtained and evaluated for typical physical properties. The evaluation results are shown in Table 1.

The data shown in the table reveal that resin compositions low in hardness and excellent in oil resistance and transparency can be obtained in the systems comprising an isobutylene-based block copolymer and a thermoplastic polyurethane resin.

TABLE 1

| | | | | | | | | Com- | Com- | Com- |
|---|---|---|---|---|---|---|---|---|---|---|
| | | | | | | | | parative | parative | parative |
| | | | Example 1 | Example 2 | Example 3 | Example 4 | Example 5 | Example 1 | Example 2 | Example 3 |
| Component (a) | | SIBS | 75 | 50 | 70 | 60 | 50 | 100 | | |
| block copolymer | | SEPS | | | | | | | 100 | 50 |
| Component (b) | | TPU-1 | 25 | 50 | | | | | | 50 |
| thermoplastic | | TPU-2 | | | 30 | 40 | 50 | | | |
| polyurethane resin | | | | | | | | | | |
| Hardness | | (JIS-A) | 57 | 64 | 58 | 59 | 55 | 48 | 80 | 75 |
| Tensile strength | | (MPa) | 12.8 | 13.1 | 9.3 | — | — | 13 | 42 | 45 |
| Tensile elongation | | (%) | 580 | 610 | 540 | — | — | 600 | 480 | 550 |
| Oil | Change in | (Visual | Excellent | Excellent | — | — | — | Fair | Fair | — |
| resistance | appearance | observation) | | | | | | | | |
| in liquid | Change in | (%) | 13 | 5 | — | — | — | 15 | 29 | — |
| paraffin | weight | | | | | | | | | |
| Oil | Change in | (Visual | Fair | Excellent | Fair | Fair | Fair | Poor | Poor | — |
| resistance | appearance | observation) | | | | | | | | |
| in #3 | Change in | (%) | 30 | 15 | 25 | 21 | 15 | 40 | 64 | — |
| | weight | | | | | | | | | |

| | | | | | | | | | |
|---|---|---|---|---|---|---|---|---|---|
| Transparency | (Visual | Excellent | Excellent | Excellent | Excellent | Excellent | Excellent | Excellent | Poor |
| | observation) | | | | | | | | |

1. A thermoplastic resin composition
which comprises 30 to 95 parts by weight of (a) an isobutylene-based block copolymer constituted of a polymer block the main constituent of which is isobutylene and a polymer block derived from a monomer composition the main constituent of which is not isobutylene and 70 to 5 parts of a thermoplastic polyurethane resin.

2. The thermoplastic resin composition according to claim 1
wherein, in the isobutylene-based block copolymer (a), the monomer composition the main constituent of which is not isobutylene is a monomer composition the main constituent of which is an aromatic vinyl monomer.

3. The thermoplastic resin composition according to claim 2
wherein the aromatic vinyl monomer comprises at least one species selected from the group consisting of styrene, p-methylstyrene, α-methylstyrene and indene.

4. The thermoplastic resin composition according to claim 1
wherein the isobutylene-based block copolymer (a) comprises at least one species selected from the group consisting of triblock copolymers composed of a polymer block the main constituent of which is an aromatic vinyl monomer, a polymer block the main constituent of which is isobutylene and a polymer block the main constituent of which is an aromatic vinyl monomer, diblock copolymers composed of a polymer block the main constituent of which is an aromatic vinyl monomer and a polymer block the main constituent of which is isobutylene, and star block copolymers comprising at least three arms each composed of a polymer block the main constituent of which is an aromatic vinyl monomer and a polymer block the main constituent of which is isobutylene.
